(19) United States
(12) Patent Application Publication
(10) Pub. No.: US 2009/0296756 A1
(43) Pub. Date: Dec. 3, 2009

(54) Laser Frequency Multiplier with Temperature Control

(76) Inventors: David Cullumber, Paradise, UT (US); John Blankenagel, West Bountiful, UT (US)

Correspondence Address: MINTZ, LEVIN, COHN, FERRIS, GLOVSKY AND POPEO, P.C, ONE FINANCIAL CENTER, BOSTON, MA, 02111, US

(21) Appl. No.: 12/131,614

(22) Filed: Jun. 2, 2008

(51) Int. Cl. H01S 3/10; H01S 3/04; G02F 1/35

(52) U.S. Cl. 372/22; 372/34; 359/328

(57) ABSTRACT

Disclosed is a laser apparatus. The apparatus includes a frequency multiplier to multiply a first frequency of laser radiation to a second frequency, the frequency multiplier having a temperature that can vary over a temperature range, and a controller to control the temperature of the frequency multiplier to regulate the level of laser radiation exiting the frequency multiplier.

### BACKGROUND

The present disclosure relates to a laser system that includes a frequency multiplier, and more particularly to a laser system in which the temperature of the frequency multiplier and/or the level of radiation exiting the frequency multiplier can be controlled.

Frequency multiplier elements, such as a KTP (potassium titanyl phosphate) crystal, are used to convert the frequency of an incoming radiation emission to another frequency. For example, a KTP crystal may be used to double the frequency (i.e., half the wavelength) of an incoming 1064 nm input light (corresponding to infrared) to a light having a wavelength of 532 nm (corresponding to green light emission). The amount of output light (i.e., the level of radiation) generally depends on how the crystal is aligned relative to the path of the incoming radiation emission and on the temperature of the frequency multiplier element.

### SUMMARY

In one aspect, a laser apparatus is disclosed. The apparatus includes a frequency multiplier to multiply a first frequency of laser radiation to a second frequency, the frequency multiplier having a temperature that can vary over a temperature range, and a controller to control the temperature of the frequency multiplier to regulate the level of laser radiation exiting the frequency multiplier.

Embodiments of the laser apparatus may include one or more of the following features.

The laser apparatus may further include a laser source to generate the laser radiation. The laser source may be configured to generate one of, for example, pulsed laser radiation and continuous laser radiation.

The frequency multiplier may be configured to output a variable level of laser radiation based on the temperature of the frequency multiplier.

The controller may be configured to adjust the temperature of the frequency multiplier based on a pre-specified output level of laser radiation of the frequency multiplier.

The controller may be mounted proximate to the frequency multiplier.

The controller may include a heater to generate heat. The controller may further include a temperature sensor coupled to the controller in a feedback configuration.

The frequency multiplier may be a KTP crystal.

The laser apparatus may further include an orientation adjustment mechanism to adjust the orientation of the frequency multiplier with respect to the apparatus. The orientation adjustment mechanism may be configured to adjust the orientation of the frequency multiplier such that the output radiation level of the frequency multiplier is varied based on the adjusted orientation of the frequency multiplier. The orientation adjustment mechanism may include a pivotable assembly to vary the orientation of the frequency multiplier. The pivotable assembly may include a spring loaded mechanism to pivot the frequency multiplier.

The laser apparatus may further include a displacement mechanism to displace the frequency multiplier into a light path of the laser radiation such that the laser radiation enters the frequency multiplier.

The frequency multiplier may be configured to multiply a first frequency of a laser radiation having a pulse duration of substantially between 1 nanosecond and 1 millisecond.

In another aspect, an optical device is disclosed. The device includes a frequency multiplier to multiply a first frequency of laser radiation to a second frequency, the frequency multiplier having a temperature that can vary over a temperature range, and a controller to control the temperature of the frequency multiplier to regulate the level of laser radiation exiting the frequency multiplier.

Embodiments of the optical device may include any of the one or more features described herein in relation to the laser apparatus, as well as any of the following feature.

The frequency multiplier may be configured to multiply the first frequency of one of, for example, input pulsed laser radiation and input continuous laser radiation.

The controller may be configured to adjust the temperature of the frequency multiplier based on a pre-specified output level of laser radiation of the frequency multiplier.

In a further aspect, a method to regulate laser radiation level is disclosed. The method includes positioning in the path of laser radiation a frequency multiplier to multiply a first frequency of the laser radiation to a second frequency, the frequency multiplier having a temperature that can vary over a temperature range, and controlling the temperature of the frequency multiplier to output a specified level of laser radiation at the second frequency.

Embodiments of the method may include any of the one or more features described herein in relation to the laser apparatus and/or optical device, as well as any of the following one or more features.

Controlling the temperature of the frequency multiplier may include determining the temperature of the frequency multiplier using a temperature sensor.

Controlling the temperature of the frequency multiplier may include generating control signals to actuate a switch controlling the flow of electrical current to an electrical heater generating heat-directed at the frequency multiplier.

Controlling the temperature of the frequency multiplier may include continually measuring the temperature of the frequency multiplier.

Controlling the temperature of the frequency multiplier may include adjusting the temperature of the frequency multiplier based on a profile of varying output radiation levels.

Details of one or more implementations are set forth in the accompanying drawings and in the description below. Further features, aspects, and advantages will become apparent from the description, the drawings, and the claims.

### BRIEF DESCRIPTION OF THE DRAWINGS

FIG. 1A is a side perspective view of an exemplary pivotable assembly with a frequency multiplier.

FIG. 1B is a cross-sectional side view of the pivotable assembly of FIG. 1A.

FIG. 1C is a top cross-sectional view of the assembly of FIG. 1A.

FIG. 2 is a circuit diagram of an exemplary control module to control the temperature of a frequency multiplier.

FIG. 3 is a schematic diagram of an exemplary laser system.

FIG. 4 is a flowchart of an exemplary frequency multiplier calibration procedure.

FIG. 5 is a flowchart of an exemplary procedure to regulate the level of radiation outputted by a frequency multiplier.

Like reference numbers and designations in the various drawings indicate like elements.

### DETAILED DESCRIPTION

Described herein is a laser apparatus that includes a frequency multiplier, such as a KTP crystal, to multiply a first wavelength of laser radiation to a second wavelength, and a controller to control the temperature of the frequency multiplier to, for example, regulate the level of laser radiation exiting the frequency multiplier. The temperature of the frequency multiplier can be varied over a temperature range. The frequency multiplier outputs different radiation levels for different temperatures (for a particular input radiation level and for a particular orientation of the frequency multiplier).

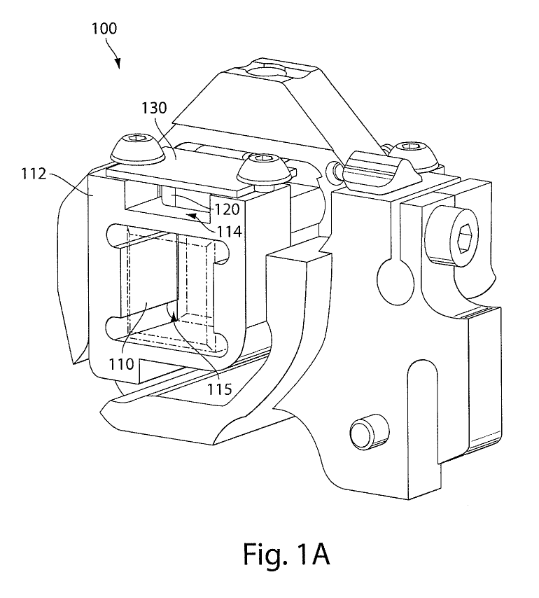

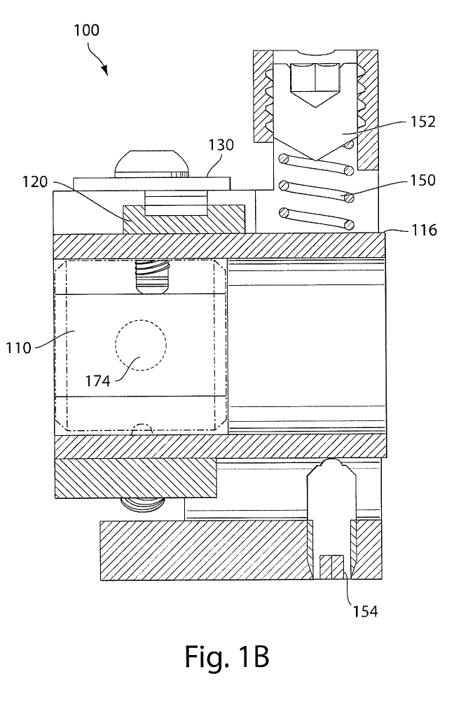

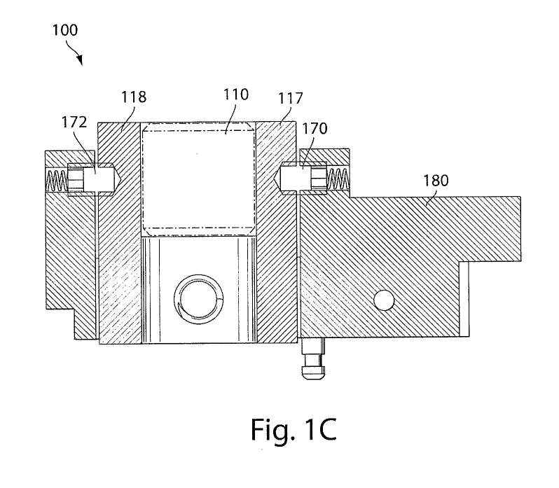

Referring to FIG. 1A, a side perspective view of an exemplary pivotable assembly 100 that includes a frequency multiplier is shown. The assembly 100 includes a frequency multiplier 110, such as a KTP crystal, that is mounted on a support structure 112 configured to firmly hold the KTP in position such that movement of the frequency multiplier 110 relative to the structure in the course of normal operation is minimized (i.e., so that the level of wobbling or spatial displacement of the frequency multiplier 110 is minimized). The frequency multiplier 110 includes a nonlinear material that when exposed to input radiation (e.g., intense collimated light beam) it causes the radiation frequency to change. For example, in embodiments in which the frequency multiplier causes frequency doubling, infrared light that enters the frequency multiplier will result in light at half the input wavelength and infrared light of the input wavelength exiting the frequency multiplier. The level of light radiation at half the input wavelength will depend, at least in part, on how the crystal is spatially oriented with respect to the direction of the propagating radiation (e.g., the angle at which the light is incident on the surface of a crystal-based frequency multiplier) and/or the temperature of the frequency multiplier.

In some embodiments, the crystal employed in implementing the frequency multiplying functionality is configured to double the frequency of an incoming radiation (i.e., produce a resultant output radiation having a wavelength that is half the wavelength of the incoming input radiation to the frequency multiplier). For example, and as will be described below in greater detail, in some embodiments, laser apparatus, such as the Selecta laser apparatus manufactured by Lumenis Ltd., that use radiation wavelengths of 1064 nm and 532 nm (each used for different therapeutic treatment procedures), employ a crystal to convert, for example, 1064 nm radiation generated by Nd:YAG laser devices to a radiation having a wavelength of 532 nm (corresponding to green color). In some embodiments, the frequency conversion crystal used is a KTP (potassium titanyl phosphate) crystal. Other suitable crystals that may be used to perform frequency conversion functions include BBO (β-barium borate) crystals, KDP (potassium dihydrogen phosphate) crystals, and lithium niobate crystals.

Frequency multiplier crystals are generally constructed from transparent birefringent materials having a specific crystal symmetry. These materials are resistant against the high-intensity laser light (i.e., they are not damaged by the light laser energy). In some embodiments, a crystal-based frequency multiplier causes laser emission that enters the crystal and is separated into two polarization components. For example, if the laser emission has an initial polarization at 45° two components, a vertical component and a horizontal component, result. The vertical component travels more slowly than the horizontal component and therefore the spatial position of the frequency multiplier has to be adjusted so that the phases of the vertical and horizontal components match. This phase matching is required to control the level of output radiation (i.e., the radiation emission whose frequency has been converted relative to the frequency of the incoming radiation emission) exiting the frequency multiplier. In some embodiments, the frequency multiplier 110 is coated with an antireflective coating (AR) and/or with filtering coating adapted to block certain input wavelength and let other wavelengths pass into the frequency multiplier. In some embodiments, the exit surface (or port) of the frequency multiplier may be coated with filtering coating that enables certain wavelengths (e.g., corresponding to a wavelength component of radiation that was decomposed by the operation of the frequency multiplier) to exit, while preventing other wavelength (e.g., corresponding to another component of the decomposed input radiation) from exiting the frequency multiplier.

As further shown in FIG. 1A (and as shown in FIG. 1B), the assembly 100 also includes a heater 120, disposed proximate the frequency multiplier 110, that is configured to generate heat directed at the frequency multiplier 110 to thus control its temperature. The conversion efficiency (i.e., the ratio of the output radiation level and the input radiation level of the frequency multiplier) is based, at least in part, on the temperature of the frequency multiplier. In circumstances where, for a particular set temperature, an optimal or near optimal alignment of the frequency multiplier 110 relative to the radiation emission has been determined, variation of the set temperature (e.g., increase or decrease of the temperature from the set point) will result in an increase or a decrease in the conversion efficiency of the frequency multiplier, and thus will change the level of radiation exiting the frequency i 5 multiplier. Generally, a change in temperature will cause the molecular structure of the frequency multiplier (e.g., a crystal-based frequency multiplier) to expand or contract, and as a result the propagating components of the radiation passing through the frequency multiplier will be out of phase and will thus interfere destructively. Consequently, the conversion efficiency of the frequency multiplier will be reduced. As will become apparent below, in some embodiments, controlling the temperature of the frequency multiplier enables controlling the conversion efficiency of the frequency multiplier, thus enabling regulating the level of radiation that exits the frequency multiplier (i.e., the radiation having the converted frequency). In other words, the use of a heater, or some other type of temperature control mechanism to control the temperature of the frequency multiplier 110 enables implementing a radiation regulation mechanism so that the frequency multiplier can be used, for example, as an attenuator to control the level of exiting radiation. In some embodiment, the heater 120 may be controlled to maintain the temperature of the frequency multiplier at a constant temperature (e.g., at some pre-determined temperature such as 35°-50° C.; a suitable temperature is 42° C.) to enable the level of output radiation exiting the frequency multiplier to be substantially constant (for some specific input radiation level), thus avoiding radiation fluctuations in situations where the delivery of a specific radiation dosage is critical (e.g., in therapeutic treatment applications).

In some embodiments, the heater 120 is a resistive-based heating element. Suitable resistive-based heating elements include, for example, such commercial available heating elements as American Technical Ceramics resistive elements, e.g., the ATC CR12010T0100J heater, or Caddock Electronics resistive elements e.g., the Caddock MP800-100 heater, either of which includes resistive elements in a ceramic housing. Other types of resistor-based heaters, as well other heating mechanism may be used to heat the frequency multiplier 110.

As shown in FIG. 1A, the heater 120 is secured to the support structure 112 using a plate 130 that presses down on the heater 120 to keep the heater in place. As shown in the embodiment of FIG. 1A, the heater 120 is mounted in a channel 114 defined on the top surface of the support structure 112. In some embodiments, the plate 130 may be a printed circuit board (PCB) that includes an electrical interface to electrically couple the heater 120 (e.g., the resistive elements of a resistor-based heater) to a power source that delivers the power required to generate the heat and/or to a control module to regulate the power level delivered. The control module may be attached directly to the plate 130, or may be located at a location remote from the plate. In some embodiments, a thermal transfer material may be disposed between the heater 120 and the support structure 112 to efficiently transfer the heat. Suitable heat transfer materials could include, for example, heat sink compounds, heat transfer pads and/or other types of heat transfer mechanism.

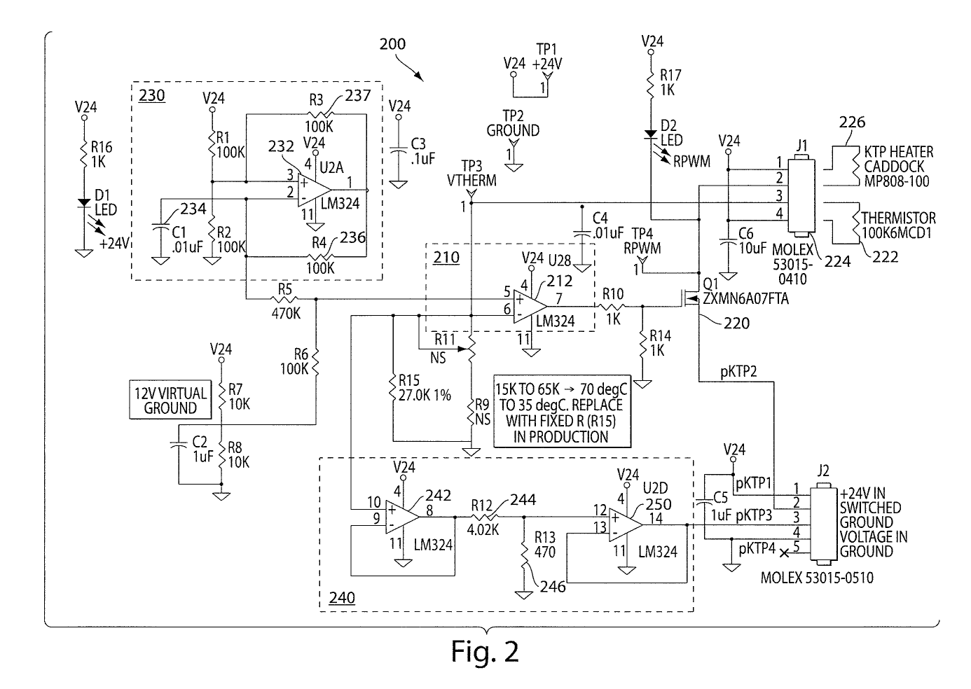

Also attached to the plate 130 is a temperature sensor (not shown in FIG. 1A) such as, for example, a thermistor (such as the thermistor 222 shown in FIG. 2) having a variable resistance that varies based on the temperature of the thermistor. The thermistor may be a positive temperature coefficient thermistor whose resistance increases as temperature increases, or a negative temperature coefficient thermistor whose resistance decreases as temperature increases. The thermistor may be spatially located near the frequency multiplier 110 and therefore the thermistor's temperature would be commensurate with the temperature of frequency multiplier 110. Thus, the resistance of the thermistor is representative of the temperature of the frequency multiplier 110. Based on that resistance value of the thermistor (which in turn affects the voltage level across the thermistor) the control module generates control signal to regulate the power level delivered to the heater 120, and thus regulates the temperature of the frequency controller.

To properly operate, the frequency multiplier needs to be carefully aligned so that the radiation emission path is incident on the entry surface 115 of the frequency multiplier 110 at an angle that achieves a desired conversion efficiency. In some embodiments, a spatial alignment that achieves the optimal conversion efficiency is determined and thereafter control of the conversion efficiency of the frequency multiplier may be achieved through control of the temperature of the frequency multiplier. Thus, the assembly 100 includes an orientation adjustment mechanism to adjust the position and/or the orientation of the frequency multiplier with respect to the apparatus.

Referring to FIG. 1B, a cross-sectional side view of the assembly 100 is shown. The assembly 100 includes a spring 150 mounted on a spring holding member 152. The spring 150 is biased in a direction extending away from the member 152 and thus presses against the surface 116 of the support structure 112. The assembly 100 also includes an adjustable set screw 154 that pushes on the surface 117 of the support structure 112 that is located opposite the surface 116. The set screw 154 is aligned approximately along the axis of the spring 150. The set screw can be adjusted to either tighten or loosen it so as to adjust the force applied on the surfaces 116 and 117 of the support structure 112. In response to an adjustment of the position of the set screw 154, the forces acting on the support structure 112 can be varied, thus causing a change in the tilt (and in turn, the orientation) of the support structure 112. Particularly, when the set screw is adjusted to a release position (i.e., unscrewing the screw to move it outwardly) the force exerted by the loaded spring 150 on the surface 116 will push the support structure in a direction that is generally away from the member 152, causing the support structure to be slightly tilted (i.e., in a downwards direction, with reference to FIG. 1B). Conversely, tightening the set screw 154 will push the support structure 112 in a direction towards the member 152, thus resulting in a tilt in the opposite direction (i.e., a generally upward tilt, with reference to FIG. 1B).

Referring to FIG. 1C, a top cross-sectional view of an assembly 100 is shown (FIG. 1C also shows the top view of a displacement adjustment mechanism 180 that is not shown in FIGS. 1A and 1B). Pivot pins 170 and 172 are received in cavities defined in respective side walls 118 and 119 of the support structure 112. The pivot pins 170 and 172 define a cylindrical pivoting axis (represented as the dashed circle 174 in FIG. 1B) about which the frequency multiplier 110 pivots. Thus, to adjust the orientation of the frequency multiplier 110, the set screw 154 is adjusted to either tighten or loosen it. The adjustment of the set screw 154 controls the tilt of the support structure 112. As the support structure tilts, the frequency multiplier 110 pivots about the pivoting axis 174, thus causing a change in the orientation of the frequency multiplier 110.

As noted, control of the temperature of the frequency multiplier 110 is achieved, in some embodiments, by regulating the power delivered to the heater 120 through a control module that generates control signals based on the temperature of the heater 120 to thus cause the heater to heat or cool down. Referring to FIG. 2, a circuit diagram of an exemplary control module 200 to control the temperature of a frequency multiplier (e.g., a KTP crystal), and thus control the radiation level exiting the multiplier is shown. The control module 200 includes a comparator module 210 that generates, based on the an input voltage level representative of the temperature of the frequency multiplier 110, an output signal (e.g., “high” or “low” voltage levels) used to actuate a switch 220, e.g., a FET or MOSFET transistor to regulate the flow of current to the heating element 226 (which may be similar to the heating element 120 of FIG. 1A).

Specifically, the comparator module 210 may be implemented using an operational amplifier 212. The negative terminal (of the operational amplifier) is electrically coupled, through an arrangement of passive components, to a thermistor 222 (an interface 224, such as the commercially available MOLEX 53015-0410 wire-to-board interface may be used to wire the control module to the plate 130 to which the thermistor may be electrically coupled). As further shown, the thermistor 224 is connected to a voltage source, e.g., 24V, sufficient to power the heater to generate adequate heat to control the temperature of the frequency multiplier 110. As noted, because of the spatial proximity of the thermistor to the frequency multiplier, the temperature of the thermistor 224 will be commensurate to the temperature of frequency multiplier 110. The resistance of the thermistor 224 varies based on its temperature and thus the voltage level at the terminal of the thermistor (which is electrically coupled to the negative terminal of the operation-amplifier 212) is representative of the temperature of frequency multiplier 110.

Electrically coupled to the positive terminal of the operational-amplifier 212 is the output from a reference control signal generator module 230 configured to generate signals that are used, together with the signals representative of the temperature of the KTP heater, to control the output of the comparator module 210 used to actuate the switch 220. In the embodiment of FIG. 2, the reference control signal generator 230 is configured as a triangle wave generator, implemented using, for example, an operation amplifier 232, to generate triangle wave output signals having a period and/or frequency that depends on the values of the passive components used in the arrangement of the signal generator module 230. For example, in some embodiments, when power is applied to the control signal generator module 230, the voltage at the negative terminal of an op-amp 232 (marked U2A) will be near zero and the voltage at the positive terminal of the op-amp 232 will be at a higher voltage level, e.g., +12 volts, causing the output of op-amp 232 to swing to a high voltage (e.g., about 23V). This high voltage level will charge up a capacitor 234 (marked C1) at a charge rate based on the values of the resistor 236 (R4) and the capacitor 234. When the voltage at the negative terminal of the op-amp 232 exceeds the voltage at the positive input terminal of the op-amp 232, the output will switch to approximately ground (e.g., about 1 V) which will thus cause the capacitor 234 to discharge through the resistor R4 at a rate also determined, at least in part, by the values of the resistor 237 (R3). This will result in a square wave output at the output of the op-amp 232, and a triangle wave at the negative input of the op-amp 232. The resistor 237 (R3) provides for hysteresis to prevent high frequency oscillations at the switch points. The actual frequency of the signal will depend not only on the resistor 236 and the capacitor 234, but also on the slew rate of the op-amp 232.

Thus, in the embodiment of FIG. 2, the comparator circuit receives a triangle-wave reference signal whose period, frequency, and amplitude can be controlled (through appropriate selection of the passive components of the module 230) to cause the switch 220 to be actuated in such a way that the frequency multiplier heater 120 is activated to cause the temperature of the frequency multiplier 110 to converge to a particular temperature. Specifically, the period and amplitude of the triangle wave signal may be such that if the current temperature of KTP heater is below a desired temperature, the voltage level at the negative terminal (corresponding to the voltage signal generated by the thermistor 222) will be relatively low. As a result, the voltage level of the triangle-wave signal at the positive terminal of the op-amp 212 will reach the voltage level at the negative terminal relatively quickly as the signal is being ramped-up. At that point, the voltage at the positive terminal will exceed the voltage level at the negative terminal and cause the output of the comparator 210 to go high. Consequently, the switch 220 will be actuated to cause current to flow to frequency multiplier heater, thus causing the heater to generate more heat to heat up the frequency multiplier 110. As a result, the temperature of the frequency multiplier, and in turn, the temperature of the thermistor 222 will increase, causing a higher voltage level at the negative terminal of the op-amp 212 of the comparator module 210 to increase. Accordingly, on the next cycle of the triangle wave, it will take longer for the voltage at the positive terminal to reach the voltage level at the negative terminal, and thus the output of the op-amp 212 will be high for a shorter duration than it was in the preceding cycle of the triangle wave, thus resulting in less heat being generated. This process will continue until the temperature has converged to a point where the activation of the heater causes the temperature to be maintained at substantially the desired constant temperature.

On the other hand, in circumstances in which the temperature of the frequency multiplier is higher than the desired temperature, and a negative temperature coefficient is used, the voltage level at the negative terminal that is electrically coupled to the thermistor 222 will be relatively high. As a result, during the active period of a cycle of the triangle-wave signal generated by the control signal generator module 230, the voltage of triangle-wave signal will mostly be below the voltage level at the negative terminal of the op-amp 212, and thus the output of the op-amp 212 will be at the “high” level for a relatively short duration. Consequently, the heater 120 will be on for a relatively shorter duration, thus generating less heat, and causing the temperature of the frequency-multiplier 110 to decrease. It is to be noted that the arrangement of the thermistor 222, the comparator 210 and the control signal generator unit 230 implements a feedback control mechanism. It is also to be noted that if a positive temperature coefficient thermistor is used, the thermistor's resistance will increase with increasing temperature, and the voltage level at the negative terminal of the thermistor will drop. In circumstances in which a positive temperature coefficient is used, the thermistor is coupled to the positive terminal of the op-amp 212 and the output of the control signal generator module 230 is coupled to the negative terminal of the op-amp 212 of the comparator 210.

In some embodiments, the control signal generator module 230 is configured to generate adjustable control signals such that the temperature of the frequency multiplier can be varied. For example, another controller (not shown) may be used to cause variations to the frequency, shape, period and/or amplitude of the output control signal of the signal generator module 230 that would result in an adjustment of the behavior of the control module 200. For example, by adjusting the signal outputted by signal generator unit 230, the temperature to which the control module would cause the frequency multiplier to converge to can be changed. Thus, in some embodiments, the other controller can be used to adjust the control signal generated by the module 230 to change the temperature of the frequency multiplier to a level that would result in some desired level of attenuation for the frequency multiplier 110. In other words, by controlling the control signal generated by the signal generator 230, the level of radiation exiting from the frequency multiplier 110 can be regulated. Adjustment of the control signals generated by the unit 230 may be based, in some embodiments, on user-specified input provided, for example, via a suitable user-interface (e.g., keypad, knobs, switches, buttons, etc.). In some embodiments, adjustment of the control signals may be based on data stored in a data profile and retrieved by a processor-based device used to control the adjustments of the characteristics of the control signals.

Alternative and/or additionally, in some embodiments, the signal generator unit 230 can be implemented using one or more processor-based devices configured to generate control signals having adjustable characteristics (with respect to the shape, frequency, period and/or amplitude) to control the temperature of the frequency multiplier 110 and thus regulate the level radiation exiting the frequency multiplier. The one or more processor-based devices may be configured to execute one or more computer programs to generate control signal with adjustable characteristic that are used to control the temperature of the frequency multiplier 110 to regulate the level of radiation exiting the frequency multiplier 110. In some embodiments, the processor-based implementation of the signal generator unit 230 may be used to control the temperature of the frequency multiplier 110 such that the frequency multiplier's temperature converges and/or is maintained at a substantially constant desired temperature. In some embodiments, the various control and signal adjustment operations to generate adjustable control signals may also be performed, for example, by using special purpose logic circuitry, e.g., an FPGA (field programmable gate array) or an ASIC (application-specific integrated circuit).

The control module 200 further includes a signal read-back module 240 to read back the signal at the thermistor 222 to determine if the heat control is working properly. An op-amp 242 (U2C) is arranged in a unity gain amplifier configuration (i.e., the output voltage of the op-amp being substantially equal to input voltage at positive terminal) to buffer the input signal. The output voltage of the op-amp 242 is then reduced through a resistive voltage divider arrangement that includes the resistors 244 and 246 (R12 and R13, respectively). The voltage at the positive terminal of an op-amp 250 (U2D) is thus substantially equal to the voltage out of op-amp 242 multiplied by (R13/(R13+R12)). The op-amp 250 is also arranged in a unity gain amplifier configuration to buffer the signal that is sent back to an A/D converter at the processor board. The signal is digitized and the processor uses this signal to determine if the temperature of the KTP is correct and stable.

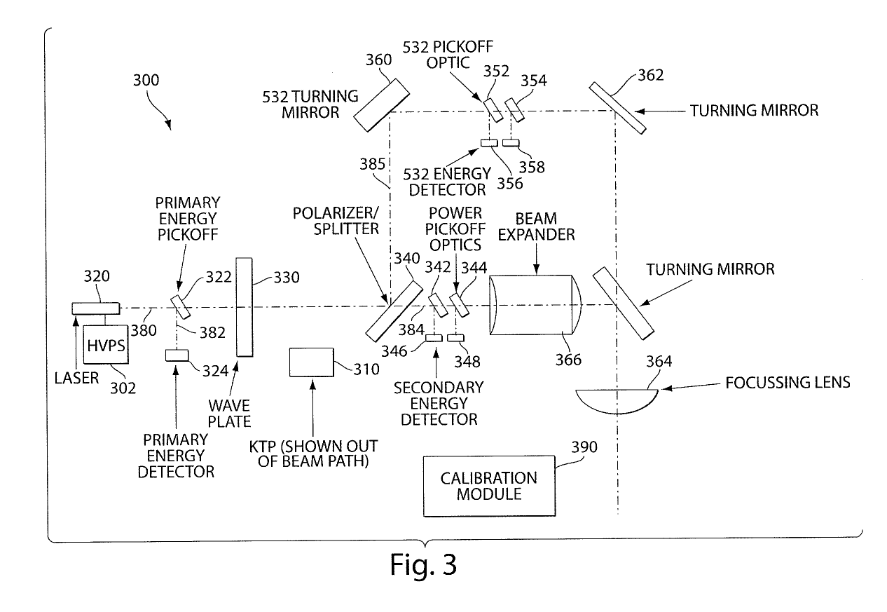

A pivotable assembly 100 with a frequency multiplier such as the frequency multiplier 110 described herein may be used in laser systems, including such laser systems used to perform therapeutic procedures. The frequency multiplier used in conjunction with such laser systems may be configured to output variable radiation levels based, for example, on controlling the temperature of the frequency multiplier. Under those circumstances, the frequency multiplier may be used as a controllable attenuator. Referring to FIG. 3, a schematic diagram of an exemplary laser system 300 is shown. In some embodiments, the laser system 300 may be a dual-path ophthalmic laser system to enable an operator to select a mode of treatment to be administered to a patient by altering the configuration of the system by, for example, inserting a suitable optical element into the light path, e.g., a frequency multiplier included in a pivotable assembly 310, which may be similar to the frequency multiplier 110 included in the pivotable assembly 100 described herein. Particularly, in some embodiments, the laser system 300 may be operated at two wavelengths. In one such configuration, radiation for use in photodisruptive (PD) treatment procedures (e.g., to treat conditions such as secondary cataract) may be required. Treatment of PD is generally performed with radiation emissions at around 1064 nanometers and energy levels of, for example, 0.3-10 mJ in an 8-10 μm spot. In another configuration, radiation with a wavelength suitable for performing Selective Laser Trabeculoplasty (SLT) to treat, for example, glaucoma, may be required. Treatment of SLT is generally performed with radiation emission at around 532 nanometers (i.e., radiation frequency approximately double the radiation frequency required for PD treatments) and energy levels of, for example, 2 mJ, or less, in an 400 μm spot. Additional descriptions of laser systems, including dual-path laser systems, are provided, for example, in U.S. patent application Ser. No., 11/399,623 (PG Publication No. 2007/0093794), entitled “Device, System and Method for Dual-Path Ophthalmic Device,” and the concurrently filed application “Method and System to Calibrate Laser Devices Used in Medical Application”, the contents of all which are hereby incorporated by reference in their entireties.

As shown, the laser system 300 includes a laser device 320 to generate and emit laser radiation. The laser device 320 may be any suitable laser, including, for example, a Q-switched Nd:YAG laser operating in the infrared spectrum at, for example, a wavelength of 1064 nm and having pulse widths of, for example, less than 5 nanoseconds. A laser operating in pulsed mode, e.g., a Q-switched Nd:YAG, includes an optical switch that is inserted in the laser cavity that opens upon reaching a maximum population inversion (i.e., achieving a state in which sufficient atoms in the laser cavity are in an excited state), thus resulting in an emission of one or more pulses. Other laser devices, such as, for example Nd:YLF lasers, Yb:YAG lasers, etc., may also be employed. The laser device 320 is configured to fire one or more pulses based on the voltage levels applied to it by a high voltage power supply (HVPS) 302. Generally, a particular voltage level associated with the laser device 320 will cause a single pulse emission to occur, whereas other voltage levels associated with the laser device will cause additional pulses to be emitted. The voltage required to cause pulsed radiation emissions depends, at least partly, on the laser device's temperature. In some embodiments, the output of laser device 320 is polarized to enable proper operation of the optical components such as the wave plate attenuator 330 and/or splitter 340. In some embodiments, a laser device configured to generate and emit continuous wave radiation (i.e., CW radiation) may be used.

In some embodiments, radiation 380 emitted by the laser device 320 is measured by an energy measurement device 324 configured to determine whether one or more radiation pulses have been emitted by the laser device 320 and/or measure the energy level associated with radiation pulses generated and discharged by the laser device (i.e., the radiation source). The energy device 324 is thus disposed in relative physical proximity to the output port of the laser device and can thus measure energy levels at a point where little, if any, radiation level attenuation has occurred to the source radiation 380. Energy measurements devices that are positioned close to the source generating device are referred to as primary energy detectors (or PEM—Primary Energy Monitor). The emitted radiation 380 is generally directed at an optical beam splitter 322 that causes most of the energy to continue propagating in substantially the same direction the emission was traveling at before crossing the splitter, while diverting a small portion of the radiation (e.g., 3.5% of the energy in the radiation incident on the splitter 322) towards the energy measurement device 324, e.g., at an angle of approximately 90° relative to the direction of propagation of the radiation emission 380.

The radiation incident on the energy measurement device 324 may cause a photodiode detector incorporated in the device to generate current at a level proportional to the level of the diverted radiation 382, and thus in proportion to the source radiation emission 380. The signal formed by the charge accumulated on a holding capacitor of the energy measurement device 324 (representative of the energy level of the radiation emission 380) is filtered and amplified, and directed into an analog-to-digital converter of the device 324 that converts the signal to a digital value representative of the energy level of the radiation emission 380. Further details regarding energy measurement devices, such as the device 324, that may be deployed to measure radiation energy levels at various points in the system 300 are provided, for example, in the concurrently filed application “Energy Measurement System and Method”, the content of which is hereby incorporated by reference in its entirety.

The portion of the source radiation 380 not diverted to the energy measurement device 324 is directed to an attenuator such as, for example, a half-wave plate attenuator 330. The attenuator 330 is configured to attenuate the energy level of the incident radiation to a level suitable for therapeutic applications. For example, in some embodiments, the laser device 320 may generate laser radiation having an energy level of greater than 20 mJ. Therapeutic application, on the other hand, may require energy levels lower than that (e.g., in the range of 1-10 mJ). The level of attenuation (and thus the level of energy of the exiting radiation) may be controlled, for example, by changing the orientation/position of the half-wave plate attenuator 330 relative to the source radiation source 320 and other mechanisms and/or procedures for controlling and/or regulating the radiation entering the half-wave plate attenuator. For example, in some embodiments, the attenuator 330 is implemented using a birefringent material which may be mechanically or electrically controlled to vary the amount of polarization rotation it produces. Such a birefringent half-wave plate may be rotateable about an axis substantially parallel to the propagation path of the laser beam and having its optic axis aligned, for example, perpendicular to the axis of rotation. The relative angular position of the half-wave plate implementation of the variable attenuator relative to the general propagation direction of the incoming input radiation emission may be controlled, for example, using a rotational mechanism. Rotational mechanisms may include a motor (e.g., an electrical motor) that rotates the half-wave waveplate. Control of the waveplate could be provided, for example, by a stepper motor utilizing a gear reduction ratio (e.g. 64:1) to provide an accurate waveplate position. The stepper motor controller provides the signals required to move the stepper motor. The stepper motor has a gear attached to the output shaft. The motor gear interfaces with a larger gear on the waveplate assembly. The ratio between the motor drive gear and waveplate gear may be, in some embodiments, 2.75:1.

As noted, a pivotable assembly 310 that includes a frequency multiplier device, e.g., similar to the frequency multiplier 110, configured to convert incoming radiation to radiation emission with a higher frequency (e.g., radiation with a wavelength of approximately 532 nanometers required for SLT therapeutic procedures) is disposed, in some embodiments, between the half-wave plate attenuator 330 and a beam splitter 340. The pivotable assembly 310 may be placed into the light path manually, or automatically, for example by a motor activated by a button depressed by the operator of the device. In some embodiments, the pivotable assembly 310 may be disposed along other points in the optical paths depicted in FIG. 3. For example, the frequency multiplier device 310 may be disposed at a point beyond the beam splitter 340 used to direct the radiation from the half-wave plate 330 along an optical path 384 corresponding to the PD treatment procedure or along a path 385 corresponding to the SLT treatment procedure.

The pivotable assembly 310 may also include a heater, such as the heater 120. A control module, such as the control module 200 is in electric communication with the heater. As described herein, in some embodiments, the control module regulates the level of electrical current directed to the heater to thus control the temperature. The control module may regulate the heater based on user input e.g., a user indicating, via a user interface, the temperature and/or level of attenuation it desires, or based on pre-determined (e.g., pre-programmed) profiles stored on a storage element that can be accessed by the control module used to control the frequency multiplier of the pivotable assembly 310. In some embodiments, the control module regulates the operation of the heater so as to maintain the frequency multiplier at a substantially constant temperature.

As further shown in FIG. 3, the system 300 also includes a beam splitter 340 (also referred to as a separator-polarizer) that may transmit and/or reflect varying amounts of the incident light based on its polarization direction. The beam splitter controls which optical path to which the radiation incident on it is directed (e.g., path 384 or 385).

As further shown in FIG. 3, positioned along the optical paths at points beyond the position of the beam splitter 340 are one or more additional energy measurement devices, each of which may be implemented in a manner similar to the energy measurement device 324. Energy measurement devices detect and measure the energy of radiation processed (e.g., 25 attenuated) by one or more optical devices (e.g., the half-wave plate attenuator and/or the frequency multiplier) are referred to as secondary energy monitors (or SEM). Thus, the system 300 includes energy measurement devices 346 and 348 which receive portions of the radiation directed along the path 384 (e.g., radiation at wavelength of, for example, 1064 nanometers, and energy levels of up to 10 mJ, for performing PD treatment procedures) and, based on the signal samples held at their respective sample-and-hold modules, determine the energy levels corresponding to the radiation propagating along the optical path 384. The portions of radiation directed to these respective devices are diverted by energy diverters 342 and 344, which may be similar to the diverter 322 used to divert the portion of the source radiation 380 to the energy measurement device 324.

The system 300 further includes energy measurement devices 356 and 358 which receive portions of the radiation directed along the path 385 (e.g., radiation at wavelength of, for example, 532 nanometers, and energy levels of up to 2 mJ, for performing SLT treatment procedures) and determine the energy levels corresponding to the radiation propagating along the optical path 385. The path 385 along which the radiation propagates, is defined, for example, by use of optical devices such as turning mirrors 360 and 362. As with the energy measurement devices 346 and 348, the radiation incident on the devices' respective radiation sensors is diverted by optical diverters, such as diverters 352 and 354.

In some embodiments, the radiation propagating along either of the paths 384 or 385 is directed to a waveguide, e.g., an optical fiber (not shown), that transmits the radiation to the target area (e.g., a patient's eye). The radiation may be coupled to such a waveguide using, for example, a focusing lens 364.

Other wavelengths may be suitable for other ophthalmic applications, in which case the frequency multiplier device 310 may triple or quadruple the wavelength of the light emitted from laser module 320. In some embodiments, a cascade of frequency multipliers may be used to achieve a particular frequency conversion effect. For example, in embodiments in which the frequency is to be quadrupled, a cascade of two KTP crystals, each configured to double the frequency of the incoming radiation, may be used to multiply that source frequency by a factor of 4. In some applications, a tunable frequency multiplier device, such as an optical parametric oscillator, may be used. Other optical elements, for example, lenses, beam shapers, beam expanders (such as beam expander 366 shown in FIG. 3), attenuators and the like may be used in some embodiments.

As further shown in FIG. 3, the laser system 300 includes a calibration module 390 to perform and/or control the calibration procedures performed with respect to the various laser system 300 subsystems. The calibration module 390 may include one or more programmable processing-based devices executing one or more computer programs to perform calibration procedures that include determining relationship to describe the behavior and characteristics of the laser system's subsystems. For example, the calibration module 390 may be used to calibrate the frequency multiplier relationship to determine, for example, the frequency multiplier's output radiation level vs. temperature behavior. In some embodiments, operation of the calibration module may also be performed by, for example, special purpose logic circuitry, e.g., an FPGA (field programmable gate array) or an ASIC (application-specific integrated circuit). The calibration module 390 may also include one or more memory storage media and/or devices for storing instructions and data. The module 390 may further include one or more mass storage devices for storing data, e.g., magnetic, magneto-optical disks, or optical disks. The calibration module 390 may include a user interface to enable input-output functionality. The user interface may include a display device, e.g., a CRT (cathode ray tube) or LCD (liquid crystal display) monitor, for displaying information to the user and a keyboard and a pointing device, e.g., a mouse or a trackball, by which the user can provide input to the computer.

The calibration module 390 may further include one or more communication devices (not shown), e.g., transceivers to communicate with the various subsystems that are to be calibrated, as well as with other sensory devices from which the calibration module may receive data. Some of the subsystem and other devices with which the calibration module 390 may communicate include, for example, the pivotable assembly 310 and/or the frequency multiplier, the laser device 320, the HVPS 302 that powers that laser device 320, the energy monitors deployed in the laser system 300 and/or the half-wave plate attenuator 340. The calibration module 390 may generate control signals that are transmitted to controllable subsystems (e.g., the pivotable assembly 310 and/or the assembly's frequency multiplier).

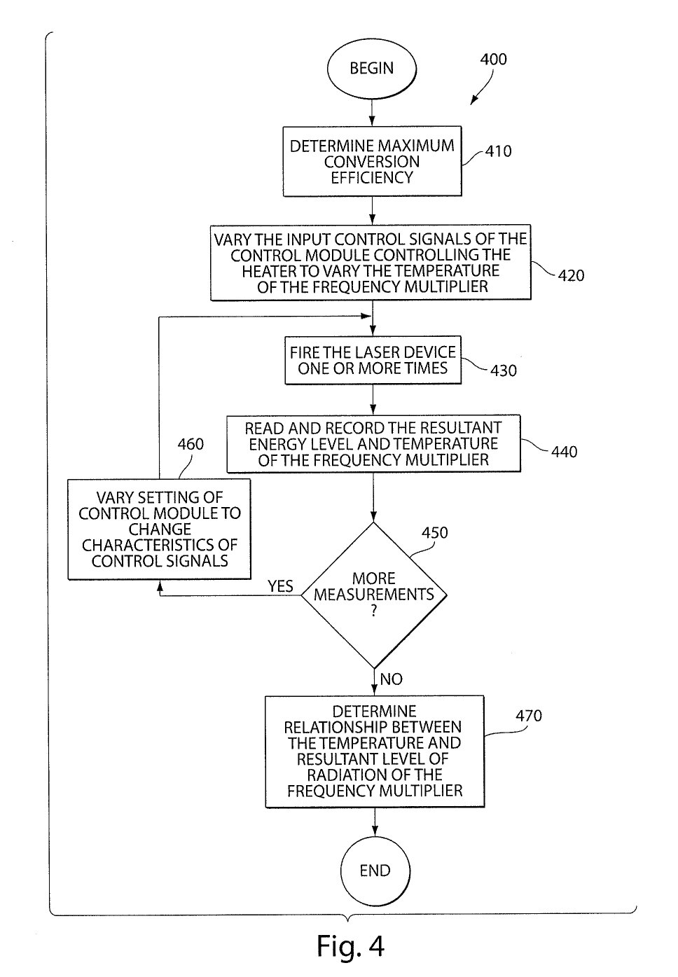

In some embodiments, the frequency multiplier (e.g., the one used in the system 300) may be calibrated to determine the relationship between the temperature of the frequency multiplier and the resultant level of attenuation (or conversion efficiency) of the frequency multiplier. Generally, to calibrate the frequency multiplier, the optimal orientation of the frequency multiplier relative to the path of the radiation emission is first determined. Referring to FIG. 4, a flowchart of an exemplary frequency multiplier calibration procedure 400 is shown. For the purpose of illustration, the description of the procedure 400 will be provided with respect to a frequency multiplier used with the laser system 300 described herein. Initially, the maximum conversion efficiency of the frequency multiplier at a particular temperature (e.g., room temperature) is determined 410. This determination can be performed, for example, by gradually changing the orientation of the frequency multiplier (e.g., by adjusting the set screw 154) and firing a laser device (e.g., a laser device such as the device 320 shown in FIG. 3) one or more times at each position/orientation of the frequency multiplier. The energy level outputted by the frequency multiplier can then be measured using, for example, one of the energy measurement devices deployed in the laser system (e.g., the energy measurement device such as the devices 324, 346, 356, etc.), or by using an external energy meter. The various measurements are recorded and the maximum energy level is identified. The position/orientation corresponding to the maximum energy level is deemed to be the position corresponding to the maximum conversion efficiency, or near maximum conversion efficiency, of the frequency multiplier at room temperature. The current room temperature of the frequency multiplier is also measured (e.g., using a calibrated temperature sensor, such as the thermistor 222) and recorded.

Subsequently, the input control signals to the comparator module 210 of the controller 200 controlling the heater are varied 420 to cause a change is the electrical current level provided to the heater 120. The change to the input control signal may be one based on changes to the period, frequency, amplitude and/or other signal characteristics of the input signals. After some pre-determine time period has elapsed (to enable the temperature of frequency multiplier to reach a substantially constant value) the laser device of the system 300 is fired one or more times 430 to cause one or more emission pulses. The resultant energy level exiting the frequency multiplier and the temperature of frequency multiplier is measured and recorded 440. If additional measurements are required, as determined at 450, the setting of the controller 200 is varied 460, and the operations of 430-440 are repeated for the new setting. If no additional measurements are required, the relationship between the temperature of the frequency multiplier and the resultant level of radiation it outputs (i.e., its level of attenuation) can be determined 470. For example, linear regression techniques may be used to determine such a relationship.

In some embodiments, the calibration procedure may be performed with respect to additional orientations. That is, the temperature vs. output radiation level behavior of the frequency multiplier may be determined for additional orientations at a particular starting temperature. Additional details regarding calibration techniques that may be used to calibrate devices/modules used with a laser system such as the laser system 300 are provided, for example, in the concurrently filed application “Method and System to Calibrate Laser Devices Used in Medical Application”, the content of which is hereby incorporated by reference in its entirety.

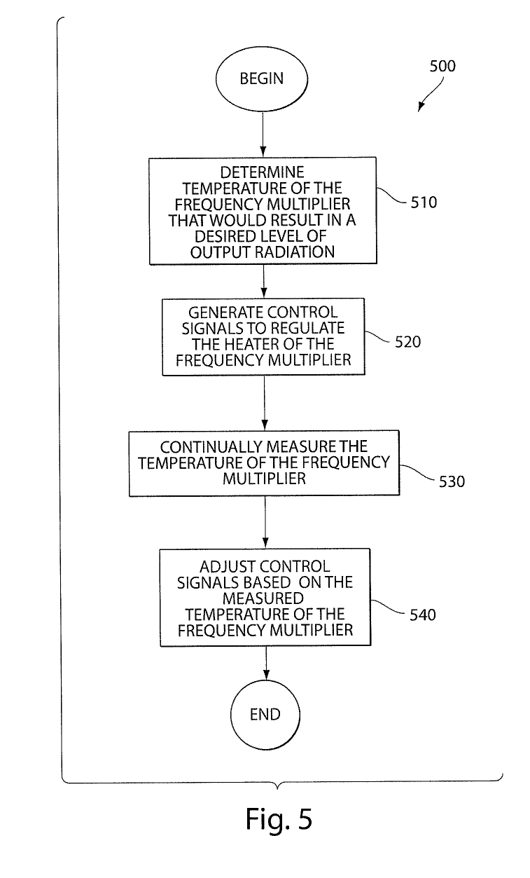

Referring to FIG. 5, a flowchart of an exemplary procedure 500 to regulate the level of radiation outputted by a frequency multiplier, such as the frequency multiplier 110, is shown. Using user specified data and/or pre-determined data profiles indicating a desired radiation level output, as well as using other data such as data representative of the orientation of the frequency multiplier, the temperature of the frequency multiplier that would result in the desired radiation level is determined 510. This determination may be based on information stored in tables relating the desired radiation level to the temperature of the frequency multiplier (and/or for a given orientation of the frequency multiplier). Additionally, or alternatively, the relationship between the radiation level and the temperature and/or orientation of the frequency multiplier 110 may be computed using derived equations representative of these relationships. In some embodiments, the output radiation level is to be adjusted over time based on a profile of varying output radiation levels (e.g., the attenuation level of the frequency multiplier is varied over time).

Based on the determined temperature, signals to regulate the heater operating on the frequency multiplier (e.g., the heater 120) are generated 520. In some embodiments, the signals generated are signals having characteristics, such as amplitude, frequency, period and/or duration, that, when provided as input to a control unit implemented using, for example, an op-amp based comparator, result in an actuating signal that actuates a switch. The actuated switch controls the flow of current to the heater 120 and thus controls the temperature of the frequency multiplier 110. The temperature of the frequency multiplier 10 is continually measured 530, and signals representative of the temperature are generated by a temperature sensor such as the thermistor 222. Those generated signals are provided, through a feedback loop to the controller, and based on the measured temperature adjustments to the control signals may be made 540. For example, if the signal representative of the temperature indicate that the temperature is too high and exceeds the required temperature (e.g., the required temperature to achieve a particular level of output radiation at the output of the frequency multiplier), the characteristics of the control signal are varied so that, for example, the period of the “high” signal of the comparator module 210 is shortened to thus cause less power to flow into the heater 120. The operations 520-540 of the procedure 500 may be repeated (including for different desired attenuation levels).

In some embodiments, the control signals to control, for example, the comparator 210 may also be adjusted based on radiation level measurements. That is, if it is determined that there is a deviation between the desired (and/or expected) output radiation level and actual measured output radiation levels, the control signals can be adjusted to cause a change of temperature of the frequency multiplier that would in turn cause a change of the radiation level being outputted by the frequency multiplier 110.

A number of embodiments of the invention have been described. Nevertheless, it will be understood that various modifications may be made without departing from the spirit and scope of the invention. Accordingly, other embodiments are within the scope of the following claims.

What is claimed is:

1. A laser apparatus, the apparatus comprising:
a frequency multiplier to multiply a first frequency of laser radiation to a second frequency, the frequency multiplier having a temperature that can vary over a temperature range; and
a controller to control the temperature of the frequency multiplier to regulate the level of laser radiation exiting the frequency multiplier.

2. The laser apparatus of claim 1 further comprising:
a laser source to generate the laser radiation.

3. The laser apparatus of claim 2 wherein the laser source is configured to generate one of: pulsed laser radiation and continuous laser radiation.

4. The laser apparatus of claim 1 wherein the frequency multiplier is configured to output a variable level of laser radiation based on the temperature of the frequency multiplier.

5. The laser apparatus of claim 1 wherein the controller is configured to adjust the temperature of the frequency multiplier based on a pre-specified output level of laser radiation of the frequency multiplier.

6. The laser apparatus of claim 1 wherein the controller is mounted proximate to the frequency multiplier.

7. The laser apparatus of claim 1 wherein the controller comprises:
a heater to generate heat.

8. The laser apparatus of claim 7 wherein the controller further comprises:
a temperature sensor coupled to the controller in a feedback configuration.

9. The laser apparatus of claim 1 wherein the frequency multiplier is a KTP crystal.

10. The laser apparatus of claim 1 further comprising:
an orientation adjustment mechanism to adjust the orientation of the frequency multiplier with respect to the apparatus.

11. The laser apparatus of claim 10 wherein the orientation adjustment mechanism is configured to adjust the orientation of the frequency multiplier such that the output radiation level of the frequency multiplier is varied based on the adjusted orientation of the frequency multiplier.

12. The laser apparatus of claim 10 wherein the orientation adjustment mechanism comprises:
a pivotable assembly to vary the orientation of the frequency multiplier.

13. The laser apparatus of claim 12 wherein the pivotable assembly comprises a spring loaded mechanism to pivot the frequency multiplier.

14. The laser apparatus of claim 1 further comprising:
a displacement mechanism to displace the frequency multiplier into a light path of the laser radiation such that the laser radiation enters the frequency multiplier.

15. The laser apparatus of claim 1 wherein the frequency multiplier is configured to multiply a first frequency of a laser radiation having a pulse duration of substantially between 1 nanosecond and 1 millisecond.

16. An optical device, the device comprising:
a frequency multiplier to multiply a first frequency of laser radiation to a second frequency, the frequency multiplier having a temperature that can vary over a temperature range; and
a controller to control the temperature of the frequency multiplier to regulate the level of laser radiation exiting the frequency multiplier.

17. The device of claim 16 wherein the frequency multiplier is configured to multiply the first frequency of one of: input pulsed laser radiation and input continuous laser radiation.

18. The device of claim 16 wherein the controller is configured to adjust the temperature of the frequency multiplier based on a pre-specified output level of laser radiation of the frequency multiplier.

19. The device of claim 16 wherein the controller comprises:
a heater to generate heat.

20. The device of claim 19 wherein the controller further comprises:
a temperature sensor coupled to the controller in a feedback configuration.

21. The device of claim 16 wherein the frequency multiplier is a KTP crystal.

22. The device of claim 16 further comprising:
an orientation adjustment mechanism to adjust the orientation of the frequency multiplier with respect to a laser device generating the laser radiation having the first frequency.

23. The device of claim 22 wherein the orientation adjustment mechanism is configured to adjust the orientation of the frequency multiplier such that the output radiation level of the frequency multiplier is varied based on the adjusted orientation of the frequency multiplier.

24. The device of claim 22 wherein the orientation adjustment mechanism comprises:
a pivotable assembly to vary the orientation of the frequency multiplier.

25. The device of claim 24 wherein the pivotable assembly comprises a spring loaded mechanism to pivot the frequency multiplier.

26. The device of claim 16 wherein the frequency multiplier is configured to multiply a first frequency of a laser radiation having a pulse duration of substantially between 1 nanosecond and 1 millisecond.

27. A method to regulate laser radiation level, the method comprising:
positioning in the path of laser radiation a frequency multiplier to multiply a first frequency of the laser radiation to a second frequency, the frequency multiplier having a temperature that can vary over a temperature range; and
controlling the temperature of the frequency multiplier to output a specified level of laser radiation at the second frequency.

28. The method of claim 27 wherein controlling the temperature of the frequency multiplier comprises:
determining the temperature of the frequency multiplier using a temperature sensor.

29. The method of claim 27 wherein controlling the temperature of the frequency multiplier comprises:
generating control signals to actuate a switch controlling the flow of electrical current to an electrical heater generating heat directed at the frequency multiplier.

30. The method of claim 27 wherein controlling the temperature of the frequency multiplier comprises:
continually measuring the temperature of the frequency multiplier.

31. The method of claim 27 wherein controlling the temperature of the frequency multiplier comprises:
adjusting the temperature of the frequency multiplier based on a profile of varying output radiation levels.
